(19) United States
(12) Patent Application Publication
(10) Pub. No.: US 2026/0261397 A1
(43) Pub. Date: Sep. 3, 2026

(54) INPUT DEVICE, INTERFACE SYSTEM INCLUDING THE SAME, AND METHOD OF OPERATING INPUT DEVICE

(71) Applicants: Samsung Display Co., Ltd., Yongin-Si (KR); Research & Business Foundation SUNGKYUNKWAN UNIVERSITY, Suwon-si (KR)

(72) Inventors: KEUMDONG JUNG, Yongin-si (KR); Juneun PARK, Suwon-si (KR); JANGHUI KIM, Yongin-si (KR); Seokhyeon MOON, Suwon-si (KR)

(21) Appl. No.: 19/421,389

(22) Filed: Dec. 16, 2025

(30) Foreign Application Priority Data
Feb. 28, 2025 (KR) 10-2025-0026758
Apr. 7, 2025 (KR) 10-2025-0044924

(51) Int. Cl. H04L 7/00; G06F 3/041

(52) U.S. Cl. CPC H04L 7/0033; G06F 3/0416

(57) ABSTRACT

Disclosed is an input device which includes a sensing electrode to receive an input signal corresponding to a modulated signal output by a host device to a sensor layer, an analog front-end to sense the input signal and convert the input signal to a digital code, a digital back-end to recover position information on the sensor layer based on the digital code, and provide the position information to the host device, and a time information recovery unit to output a recovered clock signal, which is fixed with a clock signal of the host device, based on the input signal.

### CROSS-REFERENCE TO RELATED APPLICATIONS

This application claims priority under 35 U.S.C. § 119 to Korean Patent Application Nos. 10-2025-0026758 and 10-2025-0044924 filed on Feb. 28, 2025, and Apr. 7, 2025, respectively, in the Korean Intellectual Property Office, the disclosures of which are incorporated by reference herein in their entireties.

### BACKGROUND

Embodiments of the present disclosure described herein relate to an input device, an interface system including the same, and a method of operating an input device.

Multimedia electronic devices, such as televisions (TVs), cellular phones, tablet computers, laptop computers, navigation devices, and game consoles, include a display device that displays an image. Such electronic devices may include a sensor layer (or an input sensor) that provides a touch-based input manner for enabling a user to intuitively, conveniently, and easily input information or a command, in addition to a general input manner, such as a button, a keyboard, or a mouse. The sensor layer may sense a touch or an input by a user.

There is an increasing demand for using a pen to input a fine touch for users who are accustomed to entering information using writing instruments or for a specific application (for example, an application program for sketching or drawing).

### SUMMARY

Embodiments of the present disclosure provide an input device having improved frame rate and position accuracy, an interface system including the same, and a method of operating an input device.

According to an embodiment of the present disclosure, an input device may include a sensing electrode to receive an input signal corresponding to a modulated signal output by a host device to a sensor layer, an analog front-end to sense the input signal and convert the input signal to a digital code, a digital back-end to recover position information on the sensor layer based on the digital code, and provide the position information to the host device, and a time information recovery unit to output a recovered clock signal, which is fixed with a clock signal of the host device, based on the input signal.

The time information recovery unit may include a pattern controller to determine a target pattern for obtaining phase information of the input signal, and generate reference signals corresponding to a plurality of phases, respectively, a pattern detector to compare the input signal with the target pattern, and output a detected pattern, based on a comparison result, a pattern phase detector to generate phase information based on the detected pattern and the reference signals, and a clock generator to generate the recovered clock signal, based on frequency information of the input signal and the phase information of the input signal.

The pattern controller may determine the target pattern based on the frequency information.

The pattern controller may adjust a frequency of the target pattern, based on a frequency of the input signal, which is modulated.

The pattern controller may generate the reference signals based on the recovered clock signal and the frequency information.

The pattern phase detector may include a plurality of phase comparators corresponding to the reference signals, respectively, to compare the reference signals, which correspond to the phase comparators, with the detected pattern, and generate phase comparison results, a plurality of registers corresponding to the plurality of phase comparators, respectively, to store the phase comparison results, and a selector to select a phase, which corresponds to the smallest phase difference, from among the phase comparison results stored in the plurality of registers, respectively.

The pattern phase detector may further include a post-processing unit to compare an edge of a reference signal having the selected phase with a transition timing of the detected pattern, and generate the phase information based on a comparison result between the edge with the transition timing.

The time information recovery unit may further include a delay compensator to compensate for a delay time of the detected pattern, based on a plurality of positions and phase/delay information corresponding to each of the plurality of positions.

Each of the plurality of positions may be a current position, a past position, or a future position expected.

The time information recovery unit may further include a frequency detector to sense a frequency of the input signal and generate the frequency information based on a sensing result.

According to an embodiment of the present disclosure, an interface system may include a sensor layer including a plurality of electrodes, a main driver to generate a first clock signal, a sensor driver to output a modulated signal, which includes position information, to the sensor layer, based on the first clock signal, and an input device to receive an input signal from the sensor layer, convert the input signal into a digital code, and recovered the position information, based on the digital code, in which the input device may generate a second clock signal fixed to the first clock signal, based on the input signal.

The input device may detect a target pattern from the input signal, phase differences between the target pattern and reference signals corresponding to a plurality of phases, generate phase information based on a comparison result for the phase difference, and generate the second clock signal, based on frequency information of the input signal and the phase information of the input signal.

The input device may determine the target pattern from among a plurality of patterns, based on the frequency information.

The input device may adjust a frequency of the target pattern, based on a frequency change in the modulated signal caused by sensor driver.

The input device may store a plurality of positions and phase/delay information corresponding to each of the plurality of positions, and compensate for a delay time of the input signal, based on the position information.

According to an embodiment of the present disclosure, a method of operating an input device may include determining a target pattern, based on frequency information of an input signal received, by a pattern controller, detecting the target pattern from the input signal, by a pattern detector, comparing the target pattern detected by the pattern detector with each of a plurality of reference signals corresponding to a plurality of phases, respectively, by a pattern phase detector, generating phase information based on a comparison result, by the pattern phase detector, and generating a clock signal recovered based on the frequency information and the phase information, by a pattern generator.

The determining of the target pattern may further include adjusting a frequency of the target pattern, based on a frequency of the input signal, which is modulated.

The generating of the phase information may include determining a phase having a smallest phase difference, based on the comparison result, and comparing each edge of the phase determined to have the smallest phase difference with a transition timing of the target pattern detected by the pattern detector, in which the phase information may include a comparison result between each edge of the phase and the transition timing of the target pattern.

The method of operating the input device may further include compensating for a delay time of the detected pattern, based on a plurality of positions and phase/delay information corresponding to each of the plurality of positions, by a delay compensator.

The method of operating the input device may further include sensing a frequency of the input signal and generating the frequency information based on a sensing result, by a frequency detector.

### BRIEF DESCRIPTION OF THE FIGURES

The above and other objects and features of the present disclosure will become apparent by describing in detail embodiments thereof with reference to the accompanying drawings.

FIG. 1 is a block diagram of an electronic device according to an embodiment.

FIG. 2 illustrates schematic views of electronic devices according to various embodiments.

FIG. 3A is a view illustrating a usage state of the electronic device according to an embodiment of the present disclosure.

FIG. 3B is a view illustrating a usage state of an electronic device according to an embodiment of the present disclosure.

FIG. 4 is a cross-sectional view schematically illustrating a display panel according to an embodiment of the present disclosure.

FIG. 5 is a view illustrating operations of an electronic device and an object according to an embodiment of the present disclosure.

FIG. 6 is a flowchart illustrating an operation of the interface device according to an embodiment of the present disclosure.

FIG. 7A is a block diagram illustrating a sensor layer and a sensor driver according to an embodiment of the present disclosure.

FIG. 7B is a view illustrating an interface device according to an embodiment of the present disclosure.

FIG. 8 is a view illustrating an interface device according to an embodiment of the present disclosure.

FIG. 9 is a block diagram illustrating an interface system according to an embodiment of the present disclosure.

FIG. 10 is a block diagram illustrating a time information recovery unit according to an embodiment of the present disclosure.

FIG. 11 is a view illustrating a process of recovering a clock signal by a time information recovery unit according to an embodiment of the present disclosure.

FIG. 12 is a view to explain an operation for detecting a target pattern by a pattern detector according to an embodiment of the present disclosure.

FIG. 13 is a block diagram to explain an operation of a pattern controller according to an embodiment of the present disclosure.

FIG. 14 is a view to explain an operation of changing a frequency of a target pattern by a pattern determiner according to an embodiment of the present disclosure.

FIG. 15 is a block diagram illustrating a pattern phase detector according to an embodiment of the present disclosure.

FIG. 16 is a view illustrating another example of a pattern phase detector according to an embodiment of the present disclosure.

FIG. 17 is a view to describe an operation of a post-processing circuit according to an embodiment of the present disclosure.

FIG. 18 is a view to explain a delay compensator according to an embodiment of the present disclosure.

FIG. 19 is a block diagram illustrating a clock generator and a pattern phase detector according to an embodiment of the present disclosure.

FIG. 20 is a flowchart illustrating a method of operating an input device according to an embodiment of the present disclosure.

### DETAILED DESCRIPTION

In the specification, the expression that a first component (or region, layer, or part) is “on”, “connected to”, or “coupled to” a second component refers to that the first component is directly on, connected to, or coupled to the second component or refers to that a third component is interposed therebetween.

The same reference numeral will be assigned to the same component. In addition, in drawings, thicknesses, proportions, and dimensions of components may be exaggerated to describe the technical features effectively. As used herein, the word “or” means logical “or” so that, unless the context indicates otherwise, the expression “A, B, or C” means “A and B and C,” “A and B but not C,” “A and C but not B,” “B and C but not A,” “A but not B and not C,” “B but not A and not C,” and “C but not A and not B.”

Although the terms “first”, or “second” may be used to describe various components, the components should not be construed as being limited by the terms. The terms are only used to distinguish one component, part, region, layer, or portion from another component, part, region, layer, or portion. For example, without departing from the scope and spirit of the present disclosure, a first component, a first part, a first region, a first layer, or a first portion may be referred to as a second component, and similarly, a second component, a second part, a second region, a second layer, or a second portion may be referred to as the first component, the first part, the first region, the first layer, or the first portion. The singular forms are intended to include the plural forms unless the context clearly indicates otherwise.

In addition, the terms “under”, “at a lower portion”, “above”, “an upper portion” are used to describe the relationship between components illustrated in drawings. The terms are relative and will be described with reference to a direction indicated in the drawing.

It will be further understood that the terms “comprise,” “include,” and “have” (as well as variations such as “comprising”) specify the presence of stated features, numbers, steps, operations, components, parts, or the combination thereof, but do not preclude the presence or addition of one or more other features, numbers, steps, operations, components, components, or the combination thereof.

The terms “part” and “unit” refer to a software component or a hardware component to perform a specific function. The hardware component may include field-programmable gate array (FPGA) or an application-specific integrated circuit (ASIC). The software component may refer to an executable code or data used by the executable code in an addressable storage medium. Accordingly, software components may be, for example, object-oriented software components, class components, and task components, and may include processes, functions, properties, procedures, subroutines, program code segments, driver data, firmware, microcodes, circuits, data, database, data structures, tables, arrangements or variables.

Throughout the present disclosure, structure that is presented in the context of function that is not otherwise more specifically described refers to one or more integrated circuits or microprocessors. Further, an integrated circuit or microprocessor can perform the functions of two or more structures presented in the context of function.

Unless defined otherwise, all terms (including technical terms and scientific terms) used in the specification have the same meaning as commonly understood by one skilled in the art to which the present disclosure belongs. Furthermore, terms such as terms defined in the dictionaries commonly used should be interpreted as having a meaning consistent with the meaning in the context of the related technology, and should not be interpreted in ideal or overly formal meanings unless explicitly defined herein.

Hereinafter, embodiments of the present disclosure will be described with reference to accompanying drawings.

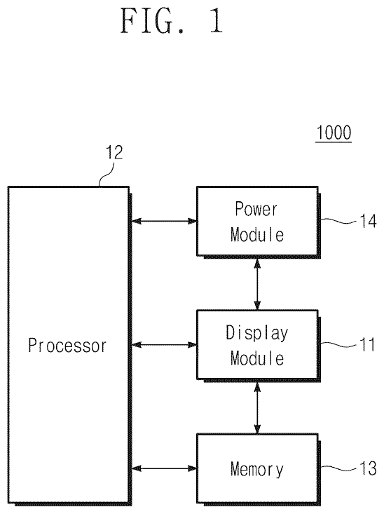

FIG. 1 is a block diagram of an electronic device 1000 according to an embodiment.

Referring to FIG. 1, the electronic device 1000 according to an embodiment may include a display module 11, a processor 12, a memory 12, and a power module 14.

The display module 11 may display an image. The image may include a still image as well as a video (or a moving image). The processor 12 may include at least one of a central processing unit (CPU), an application processor (AP), a graphic processing unit (GPU), a communication processor (CP), an image signal processor (ISP), or a controller. The processor 12 may be configured to control the operation of the display module 11.

The memory 13 may store data information necessary for the operation of the processor 12 or the display module 11. When the processor 12 runs the application stored in the memory 13, an image data signal or an input control signal may be transmitted to the display module 11, and the display module 11 may process the transmitted signal and output the image information through the display screen.

The power module 14 may include a power supply module, such as a power adaptor or a battery device, and a power converting module to convert the power supplied from the power supply module into power necessary for the operation of the electronic device 1000.

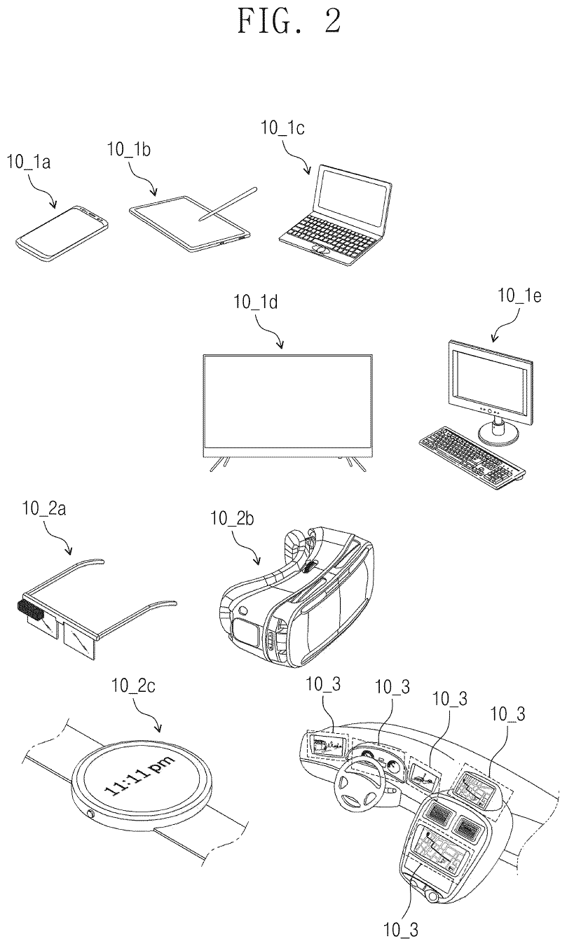

FIG. 2 illustrates schematic views of electronic devices according to various embodiments.

Referring to FIG. 2, various electronic devices employing the display device according to embodiments may include a wearable electronic device including a display module such as smart glasses 10_2a, a head mounted display 10_2b, and a smart watch 10_2c, and an electronic device 10-3 for a vehicle including the display module such as a center information display (CID), which is disposed in an instrument panel, a centerfecia, and a dashboard of a vehicle, or a mirror display, as well as an electronic device for image display such as a smartphone 10_1a, a tablet PC 10_1b, a laptop computer 10_1c, a television (TV) 10_1d, and a desk monitor 10_1e.

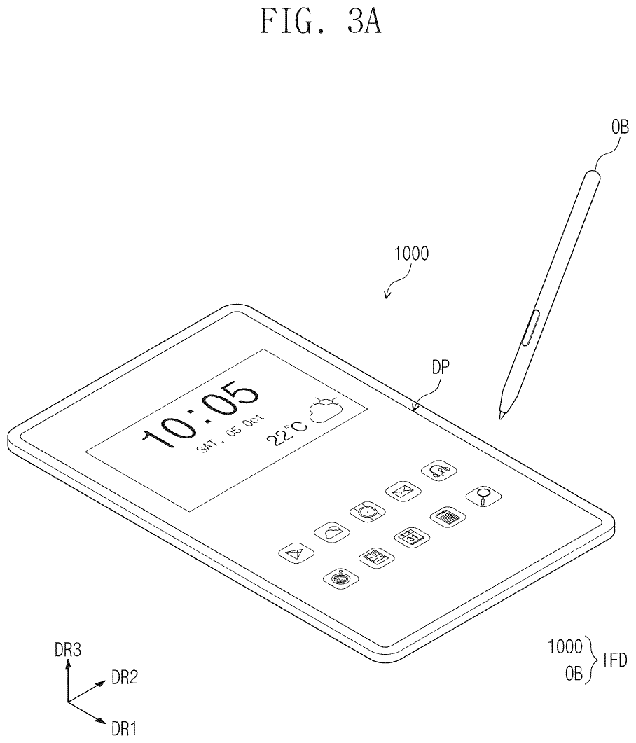

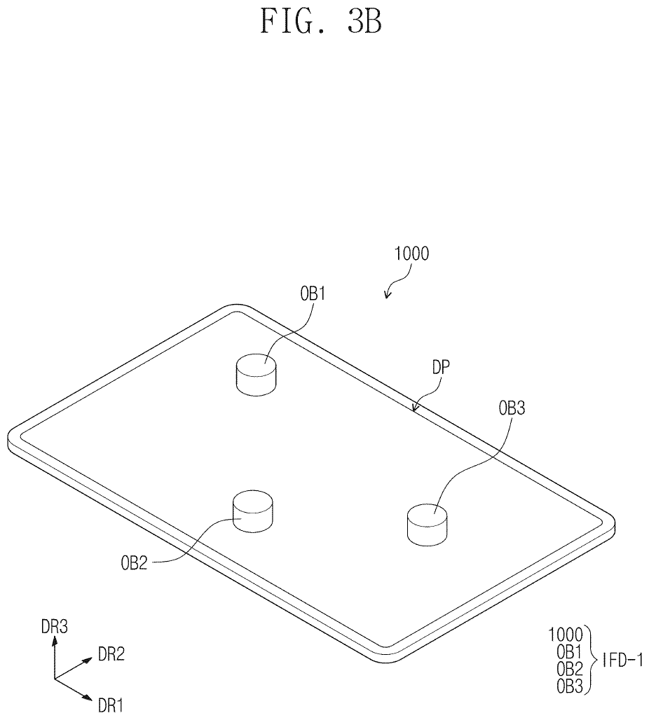

FIG. 3A is a view illustrating a usage state of the electronic device 1000 according to an embodiment of the present disclosure. FIG. 3B is a view illustrating a usage state of the electronic device 1000 according to an embodiment of the present disclosure.

FIG. 3A and FIG. 3B are views illustrating a usage state of the electronic device 1000 according to an embodiment of the present disclosure. Referring to FIGS. 3A and 3B, the electronic device 1000 may be a device which is activated in response to an electrical signal. For example, the electronic device 1000 may include a display panel DP, and the display panel DP may display an image and may sense an external input applied from outside. The external input may be a user input, and the user input may include various types of external inputs such as a part of a user's body, light, heat, or pressure. In addition, the display panel DP may transmit signals to objects OB, OB1, OB2, and OB3, the objects OB, OB1, OB2, and OB3 may be referred to as an input device, an item, a transceiver, a thing, or a peripheral device.

According to an embodiment of the present disclosure, the electronic device 1000 may communicate with the objects OB, OB1, OB2, and OB3, each of the objects OB, OB1, OB2, and OB3 may receive a signal from the electronic device 1000, may decode the signal according to a specific protocol, and may restore position information of each of the objects OB, OB1, OB2, and OB3 within the electronic device 1000. The objects OB, OB1, OB2, and OB3 may transmit the corresponding position information to the electronic device 1000.

Referring to FIG. 3A, the object OB may be a pen, and the electronic device 1000 and the object OB interacting (or communicating) with the electronic device 1000 may be referred to as an interface device IFD. Referring to FIG. 3B, the objects OB1, OB2, and OB3 may be peripheral devices allowing communicating with the electronic device 1000. The electronic device 1000 and the objects OB1, OB2, and OB3 interacting with the electronic device 1000 may be referred to as interface devices IFD-1. The interface device IFD or IFD-1 may be referred to as an interface system, an interface set, an electronic device unit, an electronic device group, or an electronic device set.

According to an embodiment of the present disclosure, the objects OB1, OB2, and OB3 may be various items such as communicable figures, cards, toys, or robots, but the present disclosure not particularly limited thereto. When the objects OB1, OB2, and OB3 are disposed in the electronic device 1000, the objects OB1, OB2, and OB3 may transmit position information to each other.

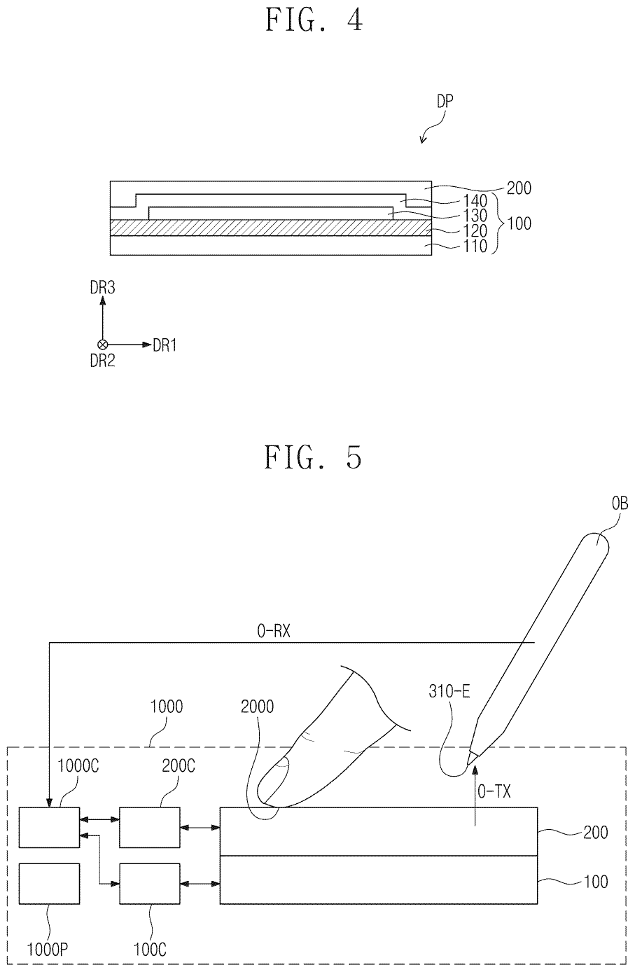

FIG. 4 is a cross-sectional view schematically illustrating the display panel DP according to an embodiment of the present disclosure.

Referring to FIG. 4, the display panel DP may include a display layer 100 and a sensor layer 200. An upper functional member may be further disposed on the sensor layer 200. For example, the upper functional member may include any one of an anti-reflective layer, a window, and a protective film.

The display layer 100 may be a component which substantially generates an image. The display layer 100 may be a light emitting display layer. For example, the display layer 100 may be an organic light emitting display layer, an inorganic light emitting display layer, an organic-inorganic light emitting display layer, a quantum dot display layer, a micro-LED display layer, or a nano-LED display layer.

The display layer 100 may include a base layer 110, a circuit layer 120, a light emitting element layer 130, and an encapsulating layer 140.

The base layer 110 may be a member which provides a base surface for disposing the circuit layer 120. The base layer 110 may be of a multi-layer structure or a single-layer structure. The base layer 110 may be implemented with a glass substrate, a metal substrate, a silicon substrate, or a polymer substrate, but the present disclosure is not limited thereto.

The circuit layer 120 may be disposed on the base layer 110. The circuit layer 120 may include an insulating layer, a semiconductor pattern, a conductive pattern, and a signal line. The insulating layer, a semiconductor layer, and a conductive layer may be formed on the base layer 110 through a coating or deposition process, and may be selectively patterned through a plurality of photolithography processes.

The light emitting element layer 130 may be disposed on the circuit layer 120. The light emitting element layer 130 may include a light emitting element. For example, the light emitting element layer 130 may include an organic light emitting material, an inorganic light emitting material, an organic-inorganic light emitting material, a quantum dot, a quantum rod, a micro-LED, or a nano-LED.

The encapsulating layer 140 may be disposed on the light emitting element layer 130. The encapsulating layer 140 may protect the light emitting element layer 130 from foreign substances such as moisture, oxygen, and dust particles.

The sensor layer 200 may be disposed on the display layer 100. The sensor layer 200 may sense an external input applied from the outside. The sensor layer 200 may be a sensor integrally formed subsequently in the process of manufacturing the display layer 100, or the sensor layer 200 may be an external sensor attached to the display layer 100. The sensor layer 200 may be referred to as a “sensor”, an “input sensing layer”, an “input sensing panel”, or an “electronic device dedicated to sense input coordinates”.

According to an embodiment of the present disclosure, the sensor layer 200 may sense an input by a passive-type input unit such as a physical body of a user. In addition, the sensor layer 200 may transmit a signal to the objects OB, OB1, OB2, and OB3 described with reference to FIGS. 3A and 3B. The details thereof will be described later.

FIG. 5 is a view illustrating the operations of the electronic device 1000 and the object OB according to an embodiment of the present disclosure.

Referring to FIG. 5, the electronic device 1000 may include the display layer 100, the sensor layer 200, a display driver 100C, a sensor driver 200C, a main driver 1000C, and a power supply circuit 1000P.

The main driver 1000C may control an overall operation of the electronic device 1000. For example, the main driver 1000C may control the operations of the display driver 100C and the sensor driver 200C. In other words, the main driver 1000C may control the operations of the display layer 100 and the sensor layer 200. The main driver 1000C may include at least one microprocessor, and may further include a graphic controller. The main driver 1000C may be referred to as a host, an application processor, a central processing unit, or a main processor. The main driver 1000C may correspond to the processor 12 described with reference to FIG. 1.

The display driver 100C may drive the display layer 100. The display driver 100C may receive image data and a control signal from the main driver 1000C. The control signal may include various signals. For example, the control signal may include an input vertical synchronization signal, an input horizontal synchronization signal, a main clock signal, and a data enable signal.

The sensor driver 200C may drive the sensor layer 200. The sensor driver 200C may receive a control signal from the main driver 1000C. The control signal may include a clock signal of the sensor driver 200C. In addition, the control signal may further include a mode selecting signal for selecting a driving mode of the sensor driver 200C and the sensor layer 200.

The sensor layer 200 may sense an input 2000 applied from the outside or transmit a signal O-TX to the object OB. For example, the sensor driver 200C and the sensor layer 200 may selectively operate in a first mode or a second mode. The first mode may be a mode for sensing a touch input, for example, the input 2000. The second mode may be a mode for transmitting the signal O-TX to the object OB.

The sensor driver 200C may calculate coordinate information of a input, based on a signal received from the sensor layer 200, and may provide a coordinate signal having the coordinate information to the main driver 1000C, in the first mode. The main driver 1000C executes an operation corresponding to a user input based on the coordinate signal. For example, the main driver 1000C may operate the display driver 100C to display a new application image on the display layer 100.

In the second mode, the sensor driver 200C and the sensor layer 200 transmit the signal O-TX, and may not receive an output signal O-RX provided from the object OB. The output signal O-RX may include position information of the object OB generated based on the signal O-TX. For example, the output signal O-RX may include information on the position of a sensing electrode 310-E of the object OB in the sensor layer 200.

The output signal O-RX provided from the object OB may be output to the main driver 1000C. For example, the output signal O-RX may be provided to the main driver 1000C through short-range communication, for example, Bluetooth communication or Wi-Fi communication.

In other words, the output signal O-RX output from the object OB is directly provided to the main driver 1000C without passing through the sensor layer 200. Accordingly, the output signal O-RX is not affected by noise which is caused in the sensor layer 200 by the display layer 100. In addition, as the output signal O-RX is directly provided to the main driver 1000C, the speed may be more improved, when compared to the case that the output signal O-RX is transmitted to the main driver 1000C through the sensor layer 200.

The power supply circuit 1000P may include a power management integrated circuit (PMIC). The power supply circuit 1000P may generate a plurality of driving voltages to drive the display layer 100, the sensor layer 200, the display driver 100C, and the sensor driver 200C. For example, the plurality of driving voltages may include a gate high voltage, a gate low voltage, a first driving voltage, a second driving voltage, or an initializing voltage, but the present disclosure is not limited thereto.

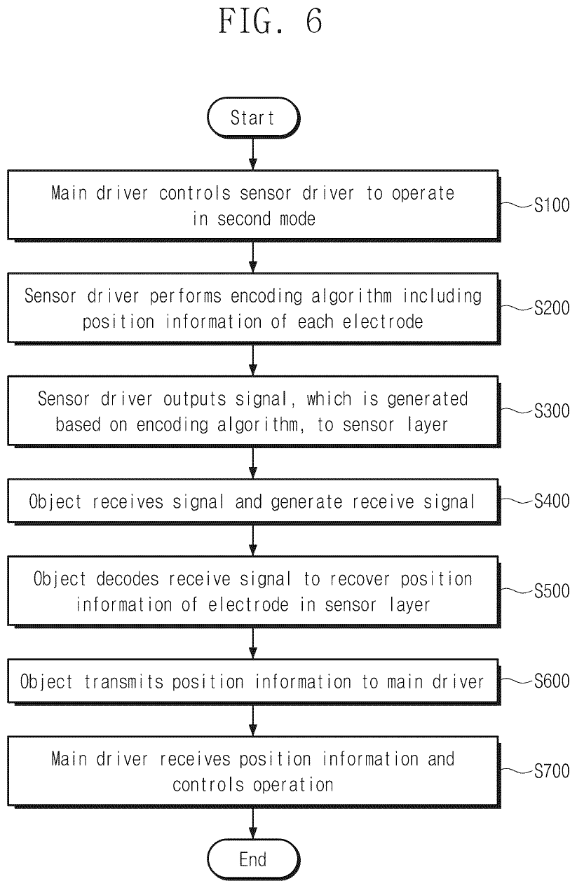

FIG. 6 is a flowchart illustrating an operation of the interface device IFD (see FIG. 3A) according to an embodiment of the present disclosure.

Referring to FIGS. 5 and 6, the main driver 1000C may control the sensor driver 200C to operate in the second mode (S100).

The sensor driver 200C may perform an encoding algorithm including position information of each electrode (S200). The sensor driver 200C may output the signal O-TX, which is generated based on the encoding algorithm, to the sensor layer 200 (S300).

The object OB may receive the signal O-TX and generate a receive signal (S400). The object OB may decode the receive signal to recover position information of the electrode in the sensor layer 200 (S500). The object OB may transmit the output signal O-RX including the position information to the main driver 1000C (S600). The main driver 1000C may receive the output signal O-RX including the position information and may control the operation of the display driver 100C or the sensor driver 200C (S700).

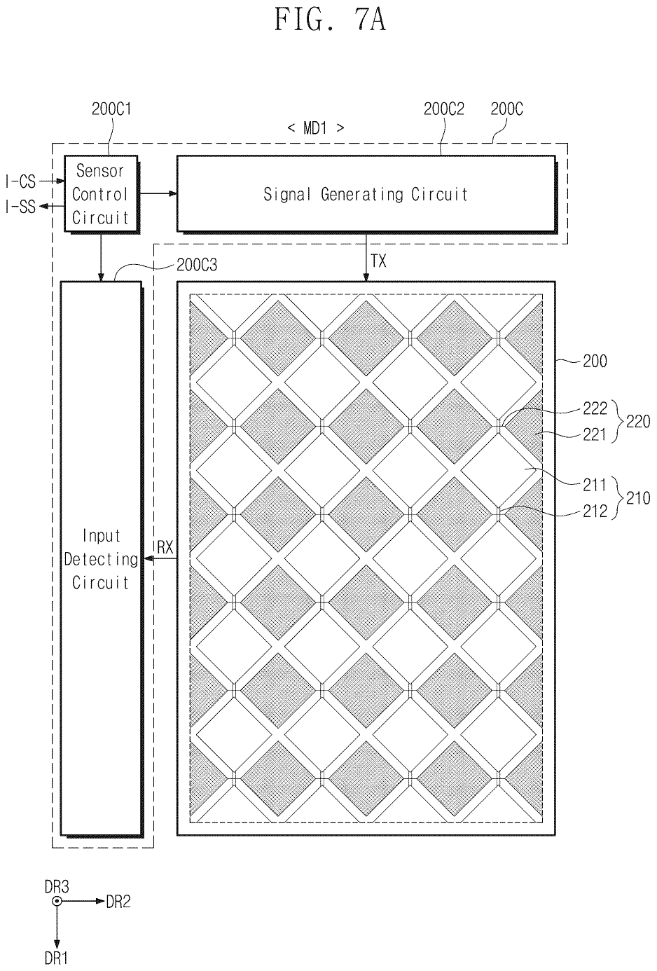

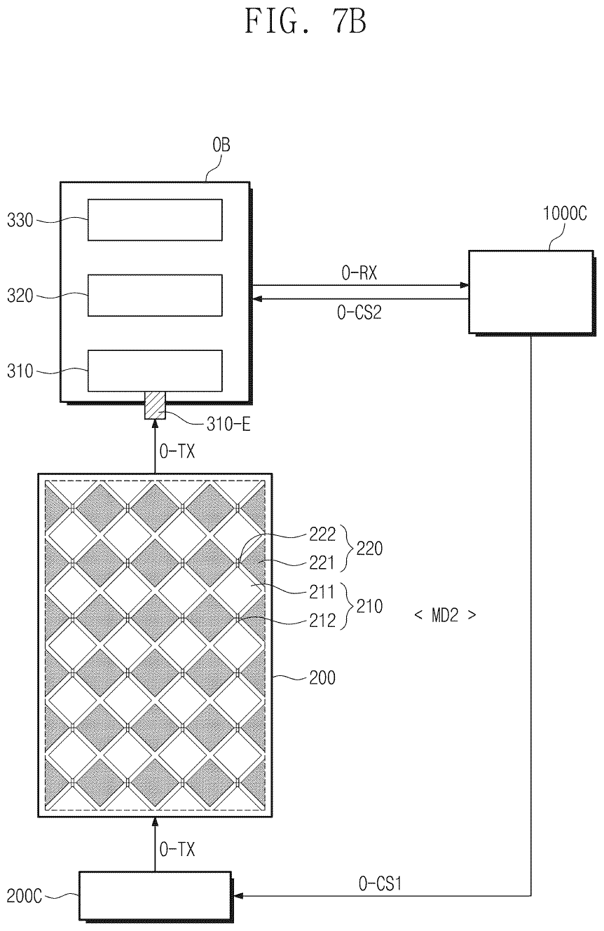

FIG. 7A is a block diagram illustrating the sensor layer 200 and the sensor driver 200C according to an embodiment of the present disclosure.

Referring to FIG. 7A, the sensor layer 200 may include a plurality of first electrodes 210 and a plurality of second electrodes 220. Each of the first electrodes 210 extends in a first direction DR1, and the first electrodes 210 may be arranged to be spaced apart from each other in a second direction DR2. Each of the second electrodes 220 extends in the second direction DR2, and may be arranged to be spaced apart from each another in the first direction DR1. Each of the second electrodes 220 may cross the first electrodes 210. Although FIG. 7A illustrates four first electrodes 210 and six second electrodes 220, the sensor layer 200 may include a greater number of the first and second electrodes 210 and 220 than illustrated.

Each of the first electrodes 210 may include a sensing pattern 211 and a connection pattern 212. Two adjacent sensing patterns 211 may be electrically connected to each other by two connection patterns 212. However, the present disclosure is not particularly limited thereto. The sensing pattern 211 and the connection patterns 212 may be disposed on mutually different layers.

Each of the second electrodes 220 may include a first part 221 and a second part 222. The first part 221 and the second part 222 may have an integral form and may be disposed on the same layer. For example, the first part 221 and the second part 222 may be disposed on a layer the same as a layer for the sensing pattern 211. The two connection patterns 212 may be electrically insulated from the second part 222 while crossing the second part 222.

The sensor driver 200C may be implemented in the form of one or more integrated circuits (ICs), and may be directly mounted on a specific region of the sensor layer 200 or may be mounted on a separate printed circuit board by a chip-on-film (COF) method so as to be electrically connected with the sensor layer 200.

The sensor driver 200C may include a sensor control circuit 200C1, a signal generating circuit 200C2, and an input detecting circuit 200C3. The sensor control circuit 200C1 may control operations of the signal generating circuit 200C2 and the input detecting circuit 200C3 based on a control signal I-CS.

The sensor driver 200C may receive the control signal I-CS from the main driver 1000C (see FIG. 5).

In a first mode MD1, the signal generating circuit 200C2 may output transmit signals TX to the first electrodes 210 of the sensor layer 200. The input detecting circuit 200C3 may receive sensing signals RX from the sensor layer 200. For example, the input detecting circuit 200C3 may receive the sensing signals RX from the second electrodes 220. In another embodiment of the present disclosure, the signal generating circuit 200C2 may output the transmit signals TX to the second electrodes 220 of the sensor layer 200, and the input detecting circuit 200C3 may receive the sensing signals RX from the first electrodes 210.

The input detecting circuit 200C3 may convert an analog signal into a digital signal. For example, the input detecting circuit 200C3 may amplify and filter the received analog signal. In other words, the input detecting circuit 200C3 may convert the filtered signal into a digital signal. The sensor driver 200C may provide a coordinate signal I-SS to the main driver 1000C.

FIG. 7B is a view illustrating the interface device IFD (see FIG. 3A) according to an embodiment of the present disclosure.

Referring to FIGS. 6 and 7B, the main driver 1000C may control the sensor driver 200C to operate in the second mode MD2. For example, the main driver 1000C may transmit a first control signal O-CS1 to the sensor driver 200C and may transmit a second control signal O-CS2 to the object OB. For example, the first control signal O-CS1 and the second control signal O-CS2 may include determined (or specific) protocol information. The first control signal O-CS1 may include an encoding algorithm (or encoding information), and the second control signal O-CS2 may include a decoding algorithm (or decoding information).

The sensor driver 200C may perform the encoding algorithm including position information of the first electrodes 210 and position information of the second electrodes 220, based on the first control signal O-CS1. Thereafter, the sensor driver 200C may output the signal O-TX, which is generated based on the encoding algorithm, to the sensor layer 200. For example, a first digital code in a time domain may be generated based on the encoding algorithm, and may be modulated to generate the signal O-TX. In other words, the signal O-TX may be an analog signal.

The object OB may include a receiver 310, a decoder 320, and a communication device 330.

The receiver 310 may include the sensing electrode 310-E, an amplifier, and an analog-to-digital converter. A capacitor may be formed between the sensing electrode 310-E, and the first electrodes 210 and second electrodes 220 of the sensor layer 200, and the object OB may receive the signal O-TX through the sensing electrode 310-E. The receiver 310 may convert the signal O-TX into a second digital code in the time domain through the amplifier and the analog-to-digital converter.

The decoder 320 may decode the second digital code to recover position information of the electrodes in the sensor layer 200. The communication device 330 may transmit the output signal O-RX including the position information to the main driver 1000C.

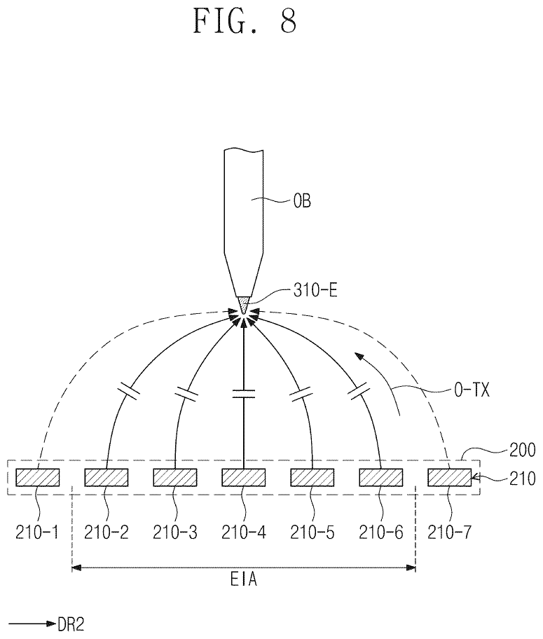

FIG. 8 is a view illustrating the interface device IFD (see FIG. 3A) according to an embodiment of the present disclosure.

Referring to FIGS. 7B and 8, seven first electrodes 210 included in the sensor layer 200, and the object OB are illustrated. The object OB may receive the signal O-TX from the first electrodes 210.

When compared to signals received, by the object OB, from five first electrodes 210-2, 210-3, 210-4, 210-5, and 210-6, which are disposed in an effective impedance region EIA, the strength of signals received, by the object OB, from first electrodes 210-1 and 210-7 disposed outside the effective impedance region EIA may be significantly weak. Although FIG. 8 illustrates that five first electrodes 210-2, 210-3, 210-4, 210-5, and 210-6 are included in the effective impedance region EIA, the present disclosure is not limited thereto.

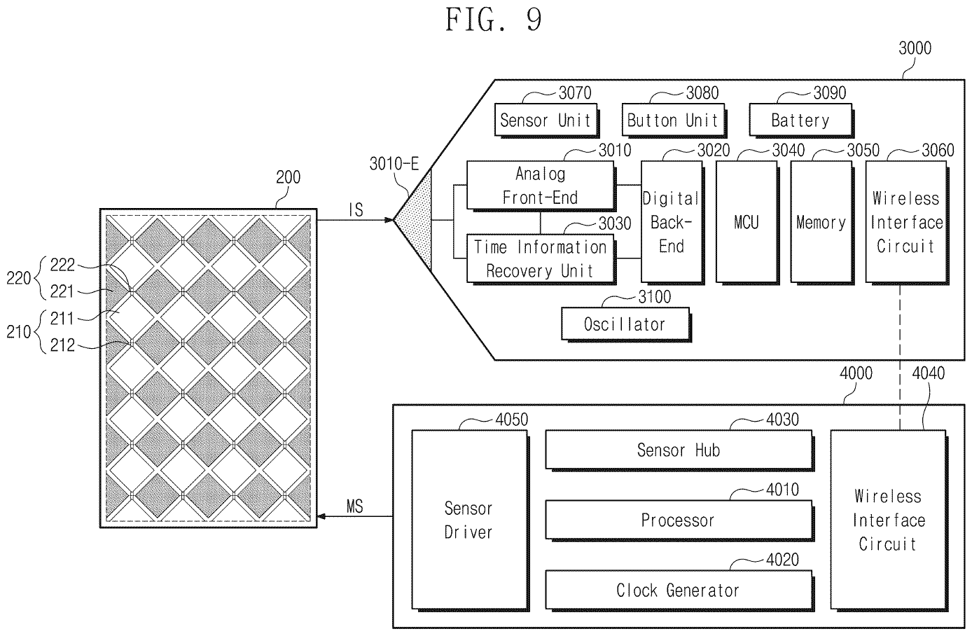

FIG. 9 is a block diagram illustrating an interface system according to an embodiment of the present disclosure.

Referring to FIG. 9, an interface system IFS may include an input device 3000 and a host device 4000.

The host device 4000 may perform an encoding operation by reflecting position information. The host device 4000 may output a modulated signal MS, which is generated as a result of the encoding operation, to the sensor layer 200. The modulated signal MS may be applied to some or all of the electrodes 210 and 220 included in the sensor layer 200.

The input device 3000 may receive an input signal IS, which is obtained based on the modulated signal MS, through some or all of the electrodes 210 and 220 in the sensor layer 200. The input device 3000 may convert the input signal IS into a digital code. The input device 3000 may decode the converted digital code to recover position information. The input device 3000 may provide position information, which is recovered, to the host device 4000.

The input device 3000 may include a sensing electrode 3010-E, an analog front-end 3010, a digital back-end 3020, and a time information recovery unit 3030.

The sensing electrode 3010-E may receive the input signal IS corresponding to the modulated signal MS which is output from the host device 4000 to the sensor layer 200. Capacitances may be formed between the sensing electrode 3010-E and the electrodes 210 and 220 included in the sensor layer 200. The modulated signal MS applied to some or all of the plurality of electrodes 210 and 220 may be induced to the sensing electrode 3010-E and may be transferred, in the form of the input signal IS, to the sensing electrode 3010-E.

The analog front-end 3010 may sense the input signal IS received by the sensing electrode 3010-E. The analog front-end 3010 may convert the sensed input signal IS into a digital code. The analog front-end 3010 may perform an amplifying operation, a noise removing operation, and an analog-to-digital converting operation with respect to the input signal IS. The analog front-end 3010 may include an operational amplifier (OP AMP) to amplify a signal, a filter to remove noise, and an analog-to-digital converter (ADC) to perform the analog-to-digital converting operation.

The digital back-end 3020 may recover the position information of the electrodes based on the digital code. The digital back-end 3020 may perform a decoding operation to recover the position information of the electrodes. The digital back-end 3020 may provide the recovered position information to the host device 4000.

The time information recovery unit 3030 may generate a recovered clock signal to be synchronized with a clock signal of the host device 4000 based on the input signal IS. The time information recovery unit 3030 may sense a specific pattern of the input signal IS. The time information recovery unit 3030 may generate the recovered clock signal based on frequency information of the input signal IS and phase information obtained from the detected pattern. The recovered clock signal may be used for operation of the input device 3000. The time information recovery unit 3030 may directly receive the input signal IS from the sensing electrode 3010-E. The time information recovery unit 3030 may also receive the input signal IS processed from the analog front-end 3010.

The input device 3000 may further include a microcontroller unit (MCU) 3040, a memory 3050, and a wireless interface circuit 3060.

The microcontroller unit 3040 may control overall operations, which include a data processing operation, of the input device 3000. The microcontroller unit 3040 may execute firmware or software loaded in the memory 3050. The microcontroller unit 3040 may perform the decoding operation with respect to the digital code stored in the memory 3050. As a result of the decoding operation, the position information may be generated.

The memory 3050 may store codes and instructions executed by the microcontroller unit 3040. The memory 3050 may store data processed by the microcontroller unit 3040. For example, the memory 3050 may store the digital code, which is converted through the analog front-end 3010, the decoded data, or the position information.

The wireless interface circuit 3060 may provide wireless communication with the host device 4000. For example, the wireless interface circuit 3060 may communicate with the host device 4000 through short-range communication, such as Bluetooth communication or Wi-Fi communication. The wireless interface circuit 3060 may transmit the position information to the host device 4000. The wireless interface circuit 3060 may also receive frequency information, phase information, or a decoding algorithm (or decoding information) from the host device 4000 to recover a clock.

The microcontroller unit 3040, the memory 3050, and the wireless interface circuit 3060 may constitute the digital back-end 3020. The operation of the digital back-end 3020 may be implemented by the microcontroller unit 3040, the memory 3050, and the wireless interface circuit 3060.

The input device 3000 may further include a sensor unit 3070, a button unit 3080, and a battery 3090. The sensor unit 3070 may sense external inputs, in addition to the sensing electrode 3010-E. For example, the sensor unit 3070 may sense various inputs such as inertia, or touch or pressure generated from the input device 3000. The button unit 3080 may sense a handling by a user. The battery 3090 may provide power for driving the input device 3000.

The input device 3000 may further include an oscillator 3100 which is separately provided. The oscillator 3100 may provide a clock signal necessary for operation of the input device 3000. Although the time information recovery unit 3030 may generate a recovered clock signal, the time information recovery unit 3030 may also generate a control signal for controlling the frequency and phase of the clock signal generated by the oscillator 3100. The following description focuses on the time information recovery unit 3030 generating the recovered clock signal.

The host device 4000 may include a processor 4010, a clock generator 4020, a sensor hub 4030, a wireless interface circuit 4040, and a sensor driver 4050.

The processor 4010 may control overall operations of the host device 4000. The processor 4010 may perform an encoding operation to include position information on the sensor layer 200. The processor 4010 may control the sensor driver 4050 to output the modulated signal MS, which is generated through the encoding operation, to the sensor layer 200.

The clock generator 4020 may generate a clock signal used by the sensor driver 4050.

The sensor hub 4030 may manage various sensor data received by the host device 4000. For example, the sensor hub 4030 may collect various data, such as illuminance data, inertial data, or touch input data, sensed by the host device 4000, and may provide the collected data to the processor 4010.

The wireless interface circuit 4040 may provide wireless communication with the outside of the host device 4000. The wireless interface circuit 4040 may communicate with the input device 3000 through short-range communication, such as Bluetooth communication or Wi-Fi communication. The wireless interface circuit 4040 may also communicate with an external network of the host device 4000.

The sensor driver 4050 may output the modulated signal MS for driving the sensor layer 200 under the control of the processor 4010. The modulated signal MS may be an encoded signal for indicating a position on the sensor layer 200. The modulated signal MS may be output, based on a clock signal generated from the clock generator 4020.

The input device 3000 may correspond to the object OB described with reference to FIGS. 3A, 5, 7B, and 8. The sensing electrode 3010-E of the input device 3000 may correspond to the sensing electrode 310-E of FIG. 7B. The analog front-end 3010 of the input device 3000 may correspond to the receiver 310 of the object OB. The digital back-end 3020 of the input device 3000 may correspond to the decoder 320 and the communication device 330 of the object OB. More specifically, the microcontroller unit 3040 and the memory 3050 of the input device 3000 may perform the operation of the decoder 320 of the object OB, and the wireless interface circuit 3060 of the input device 3000 may perform the operation of the communication device 330 of the object OB. The input signal IS received by the input device 3000 may correspond to the signal O-TX transmitted from the sensor layer 200 to the sensing electrode 310-E of FIG. 7B.

The host device 4000 may correspond to the electronic device 1000 of FIGS. 3A and 5. The processor 4010, the clock generator 4020, the sensor hub 4030, and the wireless interface circuit 4040 included in the host device 4000 may correspond to the main driver 1000C of the electronic device 1000. The sensor driver 4050 of the host device 4000 may correspond to the sensor driver 200C of the electronic device 1000. The clock signal generated by the clock generator 4020 of the host device 4000 may correspond to the clock signal included in the control signal received by the sensor driver 200C from the main driver 1000C. The modulated signal MS output by the sensor driver 4050 to the sensor layer 200 may correspond to the signal O-TX output by the sensor driver 200C to the sensor layer 200 of FIG. 7B.

The input device 3000 may determine a position on the sensor layer 200 based on the modulated signal MS output from the host device 4000. In this case, when the clock signal used for the operation of the input device 3000 and the clock signal used by the host device 4000 to generate the modulated signal MS differ from each other in frequency or phase, an error in position information may occur. Accordingly, the accuracy of the position information decoded by the input device 3000 may decrease.

The time information recovery unit 3030 may detect a specific pattern of the input signal IS and may generate phase information based on the detected pattern. The recovered clock signal may be generated based on frequency information of the input signal IS and phase information of the input signal IS. The recovered clock signal of the input device 3000 may be synchronized (or fixed) with the clock signal generated by the clock generator 4020 of the host device 4000 or the clock signal used by the sensor driver 4050. The input device 3000 may detect the input signal IS, convert the input signal IS into a digital code, and perform the decoding operation with respect to the converted digital code based on the recovered clock signal. Through synchronization between the clock signals, the accuracy of the position information determined by the input device 3000 may be improved.

The time information recovery unit 3030 may generate the recovered clock signal synchronized with the clock signal of the host device 4000 based on the input signal IS without separately receiving a control signal from the host device 4000. In addition, the time information recovery unit 3030 may generate the recovered clock signal without separately allocating time duration to correct the clock signal. Accordingly, the frame rate may be improved.

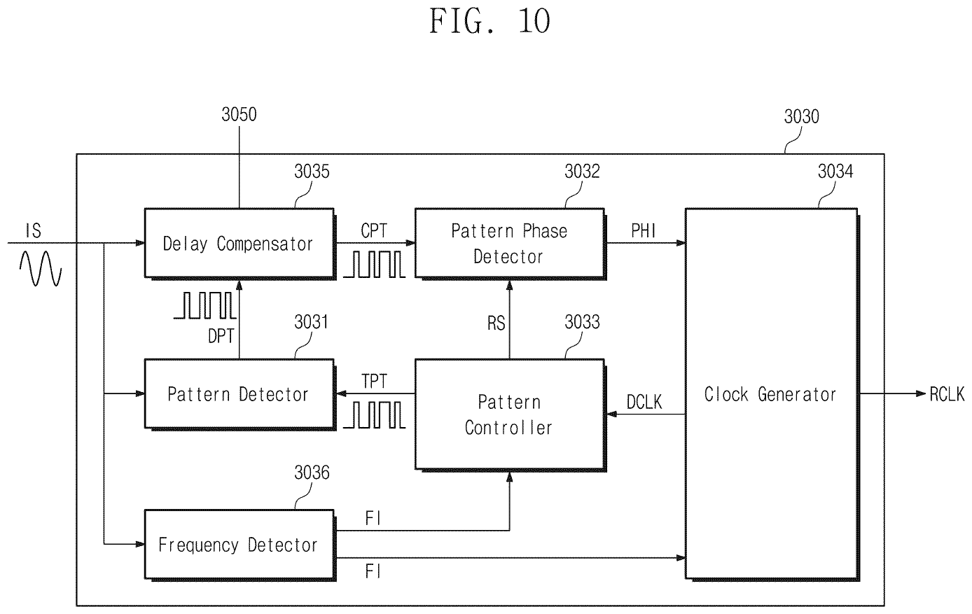

FIG. 10 is a block diagram illustrating a time information recovery unit according to an embodiment of the present disclosure.

Referring to FIG. 10, the time information recovery unit 3030 may include a pattern detector 3031, a pattern phase detector 3032, a pattern controller 3033, and a clock generator 3034.

The pattern detector 3031 may compare the input signal IS with a target pattern TPT and may output a detected pattern DPT based on a result (or comparison result) of the comparison. The target pattern TPT may be a pattern generated to be suitable for determining a phase difference between the clock signal and the input signal IS depending on the frequency of the input signal IS. The pattern detector 3031 may detect the target pattern TPT generated based on predefined information (for example, frequency information and phase information stored in the memory 3050). The pattern detector 3031 may detect the target pattern TPT of the input signal IS encrypted. The pattern detector 3031 may include a limiting amplifier to amplify the input signal IS. The limiting amplifier may expand a dynamic range of the input signal IS.

The pattern phase detector 3032 may generate phase information PHI for the input signal IS, based on the detected pattern DPT and reference signals RS which correspond to a plurality of phases. The phase information PHI may include a reference signal, which makes the smallest phase difference with the detected pattern DPT, among the reference signals RS, and a relevant phase. The phase information PHI may further include a fine phase difference between the reference signal making the smallest phase difference and the detected pattern DPT.

The pattern controller 3033 may provide the target pattern TPT to the pattern detector 3031. The target pattern TPT may be determined as an optimal pattern based on the frequency of the input signal IS among a plurality of pre-stored patterns. The target pattern TPT may also be a newly generated pattern based on the frequency of the input signal IS. Meanwhile, the pattern controller 3033 may provide the reference signals RS to the pattern phase detector 3032. The reference signals RS may correspond to the plurality of phases, respectively. The reference signals RS may also correspond to a plurality of frequencies, respectively. In other words, the reference signals RS may have different phases or different frequencies. However, hereinafter, for the convenience of explanation, the reference signals RS will be described as having different phases for one frequency.

The clock generator 3034 may recover the clock signal based on the phase information PHI and frequency information FI. The clock generator 3034 may output a recovered clock signal RCLK. The recovered clock signal RCLK may be provided to the analog front-end 3010 and the digital back-end 3020. Each of the analog front-end 3010 and the digital back-end 3020 may operate based on the recovered clock signal RCLK. The frequency information FI may be detected by a frequency detector 3036. The frequency information FI may also be provided from the host device 4000.

The time information recovery unit 3030 may further include a delay compensator 3035. The delay compensator 3035 may generate a compensated pattern CPT based on the detected pattern DPT received from the pattern detector 3031. The compensated pattern CPT may compensate for the timing of the detected pattern DPT based on a delay time according to the position of the input device 3000 on the sensor layer 200.

The time information recovery unit 3030 may further include the frequency detector 3036. The frequency detector 3036 may detect a frequency of the input signal IS. The frequency detector 3036 may generate the frequency information FI including the frequency of the input signal IS corresponding to a detection result. The frequency information FI may be provided to the pattern controller 3033 or the clock generator 3034. The pattern controller 3033 may use the frequency information FI when generating the target pattern TPT or the reference signals RS. The clock generator 3034 may use the frequency information FI when generating the recovered clock signal RCLK. The frequency detector 3036 may be used to correct a frequency offset between the clock signal generated by the clock generator 3034 and the clock signal used by the host device 4000. The frequency detector 3036 may also detect an approximate frequency range of the input signal IS. The frequency detector 3036 may also detect an approximate value of an actual frequency of the input signal IS.

Meanwhile, the pattern phase detector 3032, the pattern controller 3033, the clock generator 3034, and the frequency detector 3036 may constitute a phase-locked loop (PLL). The phase-locked loop may correct a phase of the recovered clock signal RCLK based on the detected pattern DPT or the compensated pattern CPT. The phase-locked loop may correct the frequency of the recovered clock signal RCLK based on the frequency information FI received from the frequency detector 3036. The time information recovery unit 3030 may further include a phase interpolator (not illustrated). The phase interpolator may generate a new signal by performing interpolation between the phases.

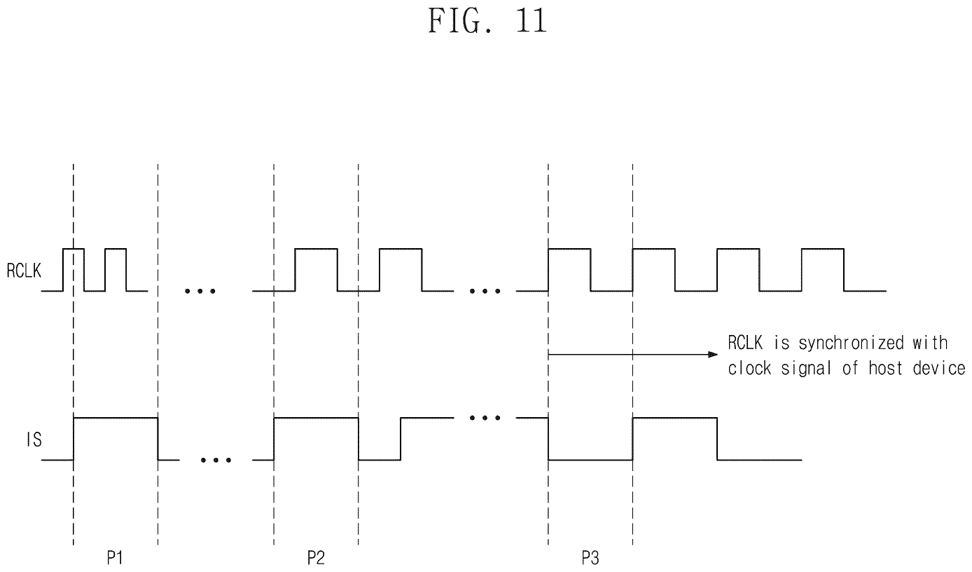

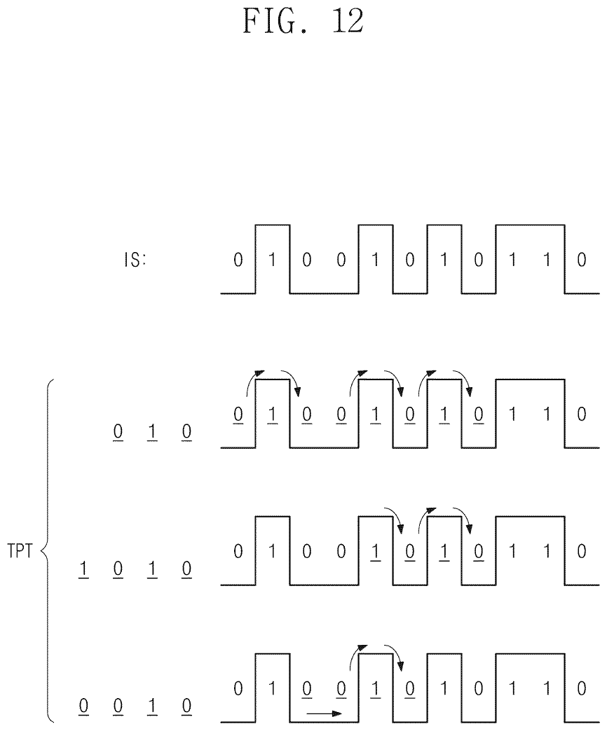

FIG. 11 is a view illustrating a process of recovering a clock signal by a time information recovery unit according to an embodiment of the present disclosure.

Referring to FIGS. 10 and 11, the time information recovery unit 3030 may output the recovered clock signal RCLK synchronized with the input signal IS. The recovered clock signal RCLK may be in the form of a pulse signal.

During a first section P1, a frequency and a phase of the recovered clock signal RCLK are different from a frequency and a phase of the input signal IS. The time information recovery unit 3030 may synchronize the frequency of the recovered clock signal RCLK with a pattern of the input signal IS based on the frequency information FI. The frequency of the input signal IS may be a preset value. The frequency of the input signal IS may be modulated. When the frequency of the input signal IS is modulated, the time information recovery unit 3030 may acquire frequency information about the input signal IS through communication with the host device 4000. The time information recovery unit 3030 may also detect the frequency of the input signal IS through the frequency detector 3036.

During a second section P2, although the frequency of the recovered clock signal RCLK is synchronized with the input signal IS, the phase of the recovered clock signal RCLK is different from a phase of the pattern of the input signal IS. The time information recovery unit 3030 may adjust the phase of the recovered clock signal RCLK based on the phase information PHI. The phase information PHI may be generated by comparing the detected pattern DPT (or the compensated pattern CPT) with the reference signals RS.

During a third section P3, the frequency and the phase of the recovered clock signal RCLK are synchronized with the frequency and the phase of the input signal IS. For example, a specific edge (for example, a rising edge) of the recovered clock signal RCLK may occur in synchronization with the signal level transition in the input signal IS. As the recovered clock signal RCLK is synchronized with the input signal IS, an error of position information may be reduced, and accuracy of the position information may increase.

FIG. 12 is a view to explain an operation for detecting a target pattern by a pattern detector according to an embodiment of the present disclosure.

Referring to FIGS. 10 and 12, the pattern detector 3031 may detect the target pattern TPT from the input signal IS.

The pattern detector 3031 may detect the target pattern TPT depending on a level transition of the input signal IS. For example, when the target pattern TPT is 010, the pattern detector 3031 may detect a pattern in which a level of the input signal IS transitions from a first level (for example, a low level corresponding to a logic value 0) to a second level (for example, a high level corresponding to a logic value 1) and transitions back to the first level. The pattern detector 3031 may detect three portions of the target pattern from the input signal IS.

As another example, when the target pattern TPT is 1010, the pattern detector 3031 may detect a pattern in which a level of the input signal IS transitions from the second level to the first level, transitions from the first level to the second level, and transitions from the second level to the first level. The pattern detector 3031 may detect one portion of the target pattern from the input signal IS.

As yet another example, when the target pattern TPT is 0010, the pattern detector 3031 may detect a pattern in which a level of the input signal IS is maintained at the first level, transitions from the first level to the second level, and transitions from the second level to the first level. The pattern detector 3031 may detect one portion of the target pattern in the input signal IS.

The input signal IS, which is a signal having position information encoded, differs from a clock signal in which ‘0 ’ and ‘1’ are repeated at a specific cycle. The target pattern TPT may be a pattern suitable for detecting the frequency or detecting a phase difference of the input signal IS. The target pattern TPT may be a preset pattern. In this case, the pattern detector 3031 may detect a preset target pattern TPT in from input signal IS. Meanwhile, the target pattern TPT may also be a pattern provided by the pattern controller 3033. The pattern detector 3031 may detect the target pattern TPT, which is provided from the pattern controller 3033, from the input signal IS.

The pattern detector 3031 may detect the target pattern TPT from the input signal IS and may output the detected pattern DPT corresponding to the detection result.

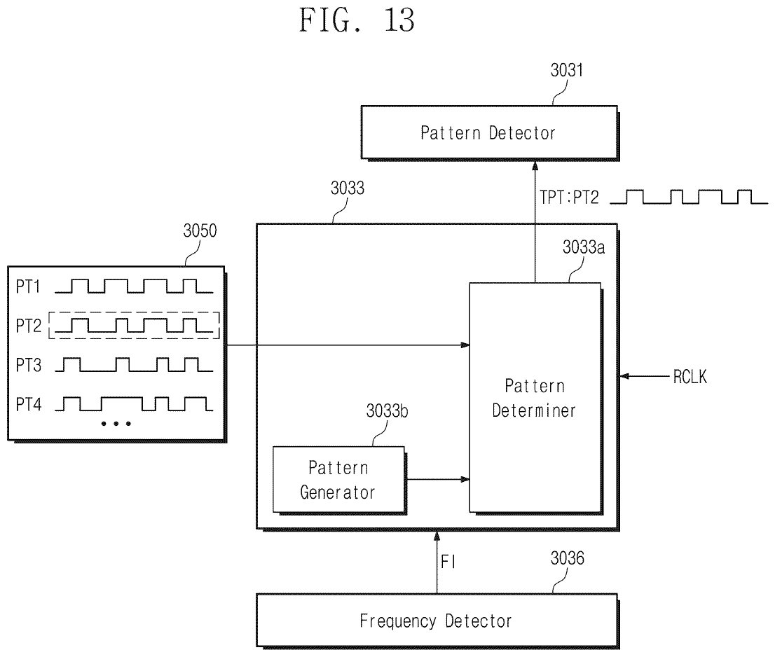

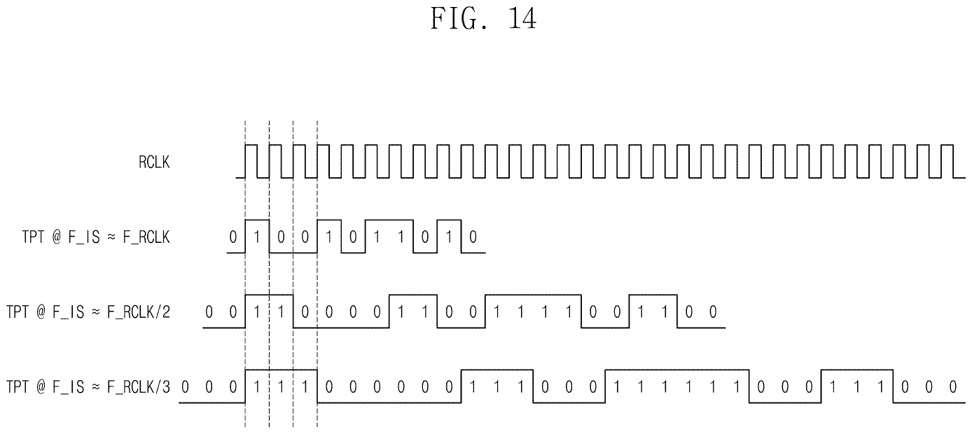

FIG. 13 is a block diagram to explain an operation of a pattern controller according to an embodiment of the present disclosure.

Referring to FIGS. 10 and 13, the pattern controller 3033 may provide the target pattern TPT to the pattern detector 3031.

The pattern controller 3033 may include a pattern determiner 3033a. The pattern determiner 3033a may determine the target pattern TPT to be provided to the pattern detector 3031. An optimal pattern for extracting a phase difference may be varied depending on a frequency of the input signal IS. The pattern determiner 3033a may determine the target pattern TPT optimized for determining the phase difference between the input signal IS and the recovered clock signal RCLK based on frequency information FI and a waveform of the recovered clock signal RCLK. At this time, the frequency information FI may include an approximate value of the frequency of the input signal IS.

The pattern determiner 3033a may select the target pattern TPT from among a plurality of patterns PT1, PT2, PT3, PT4, . . . stored in the memory 3050 or a look-up table (LUT). For example, the pattern determiner 3033a may determine the second pattern PT2 as the target pattern TPT based on the frequency information FI. The pattern determiner 3033a may provide the second pattern PT2 to the pattern detector 3031.

The pattern controller 3033 may further include a pattern generator 3033b. The pattern generator 3033b may generate the target pattern TPT based on the frequency information FI. The pattern determiner 3033a may provide the target pattern TPT, which is generated by the pattern generator 3033b, to the pattern detector 3031. The target pattern TPT generated by the pattern generator 3033b may be stored in the memory 3050 (or the look-up table).

The pattern determiner 3033a may optimize the target pattern TPT. For example, the pattern determiner 3033a may change the frequency of the target pattern TPT. The pattern determiner 3033a may multiply or divide the frequency of the target pattern TPT based on the frequency information FI. The target pattern TPT having the frequency changed may be provided to the pattern detector 3031. The pattern detector 3031 may detect a specific pattern included in the input signal IS based on the changed target pattern TPT.

The host device 4000 may generate the modulated signal MS through a frequency modulation scheme or a phase modulation scheme. The pattern controller 3033 may select a target pattern that remains fixed to a base frequency of a clock signal of the host device 4000 even if the frequency or the phase of the modulated signal MS changes. The pattern controller 3033 may also generate a target pattern that is fixed to the base frequency of the clock signal.

FIG. 14 is a view to explain an example of an operation of changing a frequency of a target pattern by a pattern determiner according to an embodiment of the present disclosure.

Referring to FIGS. 10, 13, and 14, the pattern determiner 3033a may change the frequency of the target pattern TPT based on a frequency F_RCLK of the recovered clock signal RCLK and a frequency F_IS of the input signal IS.

The input signal IS may be modulated through a frequency shift keying (FSK) scheme. The frequency F_IS of the input signal IS may be modulated based on transmitted data. The frequency F_IS of the input signal IS may be included in the frequency information FI and may be provided to the pattern controller 3033. The pattern controller 3033 may change the frequency of the target pattern TPT based on the frequency information FI and the recovered clock signal RCLK which is currently output. For example, when the frequency F_IS of the input signal IS corresponds to the frequency F_RCLK of the recovered clock signal RCLK (@F_IS≈F_RCLK), a transition of the target pattern TPT may be synchronized with one cycle of the recovered clock signal RCLK. When the frequency F_IS of the input signal IS corresponds to one-half the frequency F_RCLK of the recovered clock signal RCLK (@F_IS≈F_RCLK/2), the pattern determiner 3033a may change the frequency of the target pattern TPT to one-half, as compared to the case of “F_IS≈F_RCLK”. When the frequency F_IS of the input signal IS corresponds to one-third of the frequency F_RCLK of the recovered clock signal RCLK (@F_IS≈F_RCLK/3), the pattern determiner 3033a may change the frequency of the target pattern TPT to one-third, as compared to the case of “@F_IS≈F_RCLK”. The pattern determiner 3033a may provide an optimal target pattern TPT to the pattern detector 3031 by changing the frequency of the target pattern TPT based on the frequency F_IS of the input signal IS and the frequency F_RCLK of the recovered clock signal RCLK.

The pattern determiner 3033a may adjust a frequency of the target pattern TPT, based on a frequency change in the modulated signal MS (or input signal IS) caused by the sensor driver 200C. When the modulated signal MS obtained through a frequency modulation scheme is used, the frequency of the input signal IS may be changed. In this case, the pattern determiner 3033a may provide the optimal target pattern TPT for detecting a phase difference between the input signal IS and the recovered clock signal RCLK through the frequency modulation scheme by changing the frequency of the target pattern TPT based on the frequency F_IS of the input signal IS.

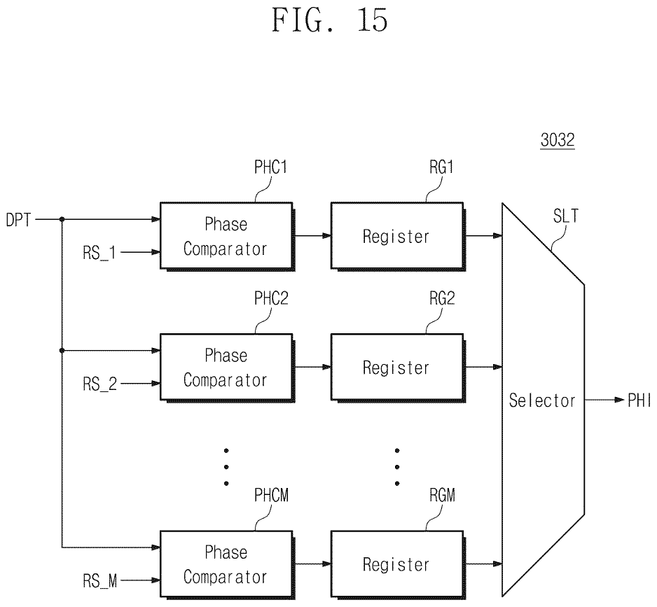

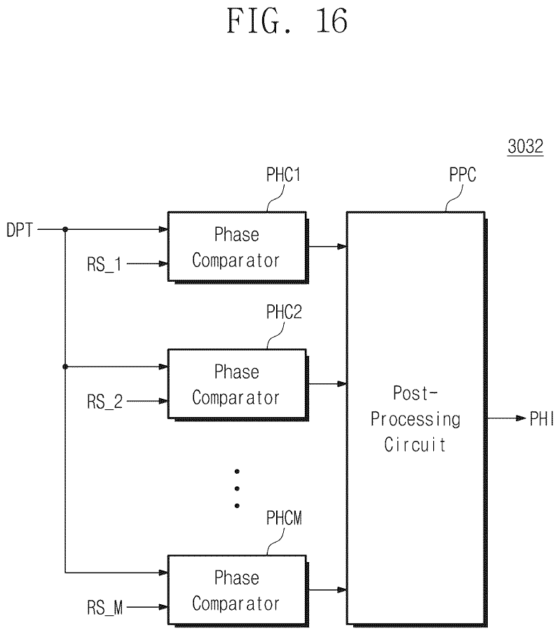

FIG. 15 is a block diagram illustrating the pattern phase detector 3032 according to an embodiment of the present disclosure.

Referring to FIGS. 10 and 15, the pattern phase detector 3032 may include a plurality of phase comparators PHC1 to PHCM, a plurality of registers RG_1 to RG_M, and a selector SLT.

Each of the plurality of phase comparators PHC1 to PHCM may receive the detected pattern DPT. Each of the plurality of phase comparators PHC1 to PHCM may receive reference signals RS_1 to RS_M corresponding to the phase comparators PHC1 to PHCM, respectively. For example, the phase comparator PHC1 may receive the detected pattern DPT and the first reference signal RS_1. The phase comparator PHC2 may receive the detected pattern DPT and the second reference signal RS_2. The phase comparator PHCM may receive the detected pattern DPT and the M-th reference signal RS_M.

The reference signals RS_1 to RS_M may correspond to different phases. For example, each of the reference signals RS_1 to RS_M may correspond to preset phases such as 0°, 45°, 90°, 135°, or 180°.

Each of the phase comparators PHC1 to PHCM may compare the detected pattern DPT with the reference signals RS_1 to RS_M (or the corresponding reference signals RS_1 to RS_M) corresponding to the phase comparators PHC1 to PHCM, respectively. Each of the phase comparators PHC1 to PHCM may compare edges of the corresponding reference signals RS_1 to RS_M with transition timings of the detected pattern DPT. Each of the phase comparators PHC1 to PHCM may store a comparison result in corresponding registers RG_1 to RG_M.

The selector SLT may select a comparison result, which corresponds to an optimal phase, from among the comparison results stored in the registers RG_1 to RG_M. The phase selected by the selector SLT may correspond to a phase difference between the recovered clock signal RCLK and the input signal IS. The selector SLT may output the phase information PHI including the phase difference between the recovered clock signal RCLK and the input signal IS.

The pattern phase detector 3032 may be implemented in a loop unrolling scheme for comparing the reference signals RS_1 to RS_M with the detected pattern DPT in parallel.

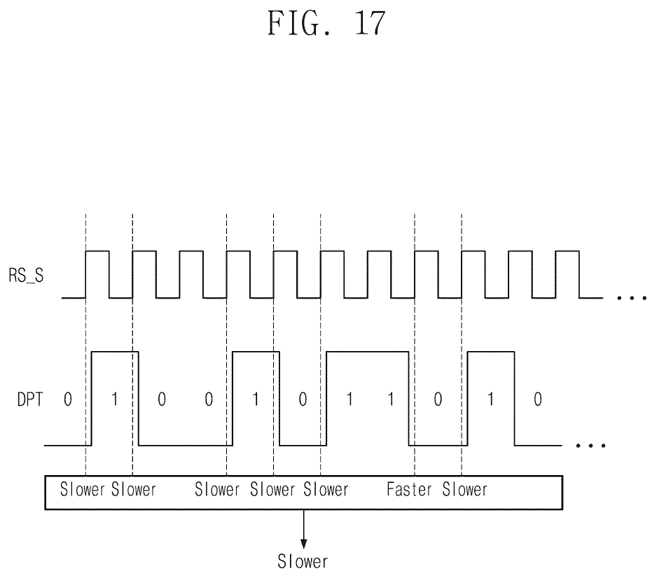

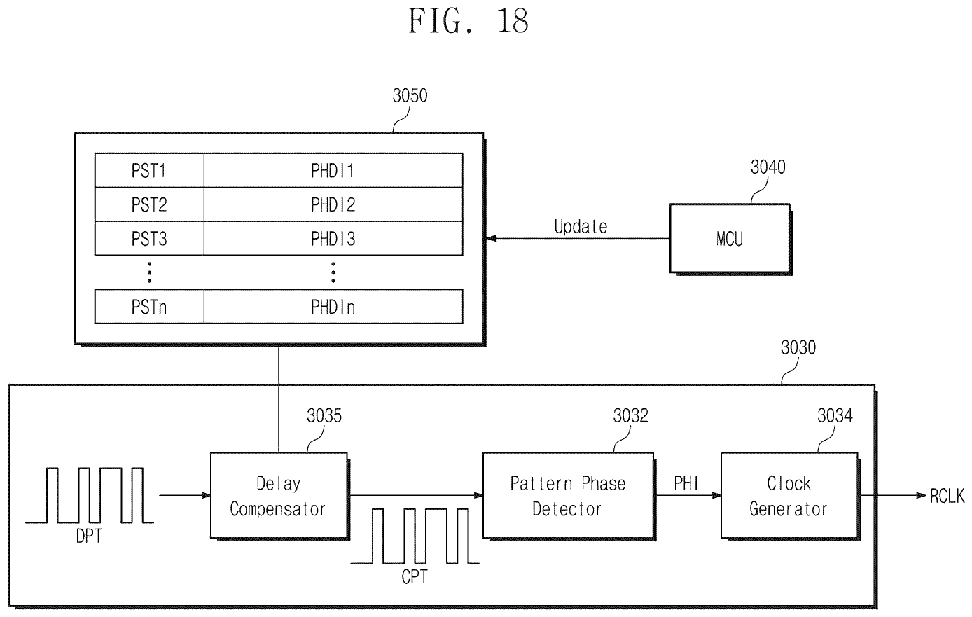

FIG. 16 is a view illustrating another example of the pattern phase detector according to an embodiment of the present disclosure. FIG. 17 is a view to describe an operation of a post-processing circuit according to an embodiment of the present disclosure.

Referring to FIGS. 16 and 17, the pattern phase detector 3032 may further include a post-processing circuit PPC.

Each of the plurality of phase comparators PHC1 to PHCM may output a comparison result between the detected pattern DPT and the corresponding reference signals RS_1 to RS_M corresponding to each of the plurality of phases.

The post-processing circuit PPC may receive outputs from the plurality of phase comparators PHC1 to PHCM. The post-processing circuit PPC may select a phase, which corresponds to the smallest phase difference, from among the comparison results of the plurality of phase comparators PHC1 to PHCM. The post-processing circuit PPC may compare the detected pattern DPT with a selected reference signal RS_S corresponding to the selected phase. For example, the post-processing circuit PPC may compare each edge (for example, a rising edge) of the selected reference signal RS_S with a transition timing of the detected pattern DPT.

The post-processing circuit PPC may output a phase relationship between the selected reference signal RS_S and the detected pattern DPT, based on the comparison result between each edge (for example, a rising edge) of the selected reference signal RS_S and the transition timing of the detected pattern DPT. At this time, the phase information PHI output by the post-processing circuit PPC may include the phase difference between the recovered clock signal RCLK and the input signal IS, and a leading or lagging (slower or faster) relationship between the selected reference signal RS_S and the input signal IS.

According to the example illustrated in FIG. 17, the detected pattern DPT may be slower than a rising edge of the selected reference signal RS_S in the first to fifth and seventh transitions and may be faster in the sixth transition. At this time, the post-processing circuit PPC may determine that the detected pattern DPT is slower than the selected reference signal RS_S. The phase information PHI generated by the post-processing circuit PPC may be provided to the clock generator 3034. The clock generator 3034 may adjust the phase of the recovered clock signal RCLK, based on the phase information PHI.

When a plurality of phase comparison results are obtained (for example, when all faster and slower relationships are detected), the post-processing circuit PPC may generate the phase information PHI including all phase comparison results. The post-processing circuit PPC may compress the plurality of phase comparison results into one comparison result. The post-processing circuit PPC may also generate the phase information PHI including a single result which is determined through a scheme, such as a majority voting scheme, a median filtering scheme, or a weighted sum scheme.

FIG. 18 is a view to explain operation of a delay compensator according to an embodiment of the present disclosure.

Referring to FIGS. 9, 10, and 18, the delay compensator 3035 may compensate for a delay time of the detected pattern DPT.

The modulated signal MS applied to the sensor layer 200 may have different delay times, depending on physical positions on the sensor layer 200, which result from various causes, such as an arrangement of the electrodes 210 and 220 included in the sensor layer 200, parasitic components of the electrodes, and frequency characteristics of the modulated signal MS. The delay compensator 3035 may compensate for the delay time corresponding to the position of the input device 3000.

The memory 3050 may store positions PST1, PST2, PST3, . . . , and PSTn (PST1 to PSTn) and phase/delay information PHDI, PHDI2, PHDI3, . . . , and PHDIn (PHDI to PHDIn) corresponding to the positions PST1 to PSTn, respectively. The delay compensator 3035 may use the phase/delay information PHDI to PHDIn stored in the memory 3050 (or the look-up table). The phase/delay information PHDI to PHDIn may correspond to each of the positions PST1 to PSTn on the sensor layer 200. The delay compensator 3035 may output the compensated pattern CPT which is compensated for the delay time of the detected pattern DPT. The compensated pattern CPT may have a waveform the same as the detected pattern DPT, but may be different from the detected pattern DPT in delay timing.

The delay compensator 3035 may obtain the phase/delay information PHDI1 to PHDIn according to a current position of the input device 3000 on the sensor layer 200. For example, when a current position of the input device 3000 on the sensor layer 200 is the first position PST1, the delay compensator 3035 may obtain the phase/delay information PHDI1 from the memory 3050 (or the look-up table). The microcontroller unit 3040 may provide a position of the input device 3000 to the memory 3050 (or the look-up table) such that the delay compensator 3035 obtains the phase/delay information PHDI1.

The delay compensator 3035 may compensate for the delay time of the detected pattern DPT based on the phase/delay information PHDI1. As a result of the compensation for the delay time, the delay compensator 3035 may output the compensated pattern CPT. Meanwhile, the delay compensator 3035 may use phase/delay information at a past position of the input device 3000 or a future position expected of the input device 3000, in addition to the current position of the input device 3000.

The microcontroller unit 3040 may learn the phase/delay information PHDI1 to PHDIn based on the phase information PHI generated by the pattern phase detector 3032. The microcontroller unit 3040 may update the learned phase/delay information PHDI1 to PHDIn.

The pattern phase detector 3032 may generate the phase information PHI based on the compensated pattern CPT. The clock generator 3034 may output the recovered clock signal RCLK based on the phase information PHI.

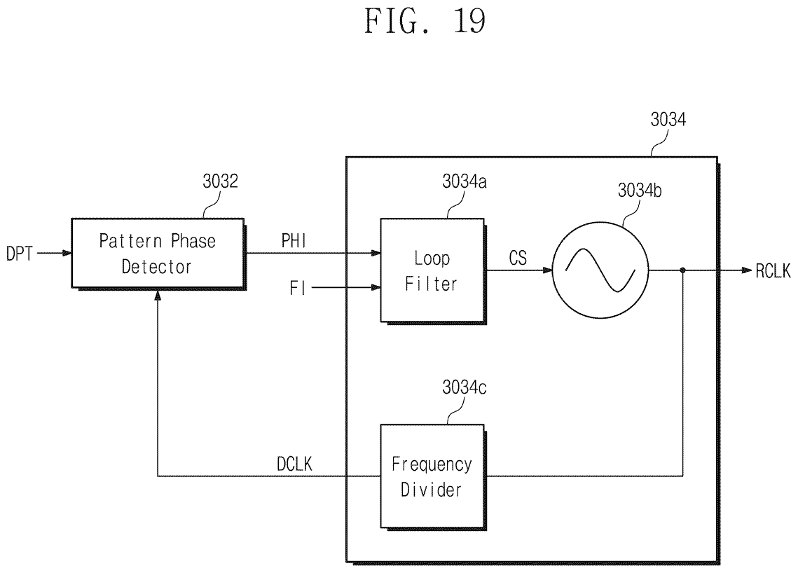

FIG. 19 is a block diagram illustrating a clock generator and a pattern phase detector according to an embodiment of the present disclosure.

Referring to FIG. 19, the clock generator 3034 may include a loop filter 3034a, an oscillator 3034b, and a frequency divider 3034c.

The loop filter 3034a, the oscillator 3034b, and the frequency divider 3034c in the clock generator 3034 may form a phase-locked loop (PLL) together with the pattern phase detector 3032.

The pattern phase detector 3032 may generate the phase information PHI for the detected pattern DPT. The loop filter 3034a may receive the phase information PHI and frequency information FI. The loop filter 3034a may generate a control signal CS based on the phase information PHI and the frequency information FI. The control signal CS is a signal for adjusting a phase and a frequency of the oscillator 3034b. The loop filter 3034a may be configured in in the form of an analog circuit or a digital circuit. The control signal CS output by the loop filter 3034a may be an analog signal or a digital signal. When the loop filter 3034a is implemented in the form of the analog circuit, the loop filter 3034a may include the analog-to-digital converter (ADC) and the digital-to-analog converter (DAC) to store the control signal CS. The digital signal or the signal converted to digital data of the loop filter 3034a may be stored in a storage device such as the memory 3050.

The oscillator 3034b may generate the recovered clock signal RCLK based on the control signal CS. The recovered clock signal RCLK may be synchronized with a clock generator 4020 or a sensor driver 4050 of the host device 4000 based on the phase information PHI and the frequency information FI.

The frequency divider 3034c may divide the recovered clock signal RCLK by a preset division ratio. The division ratio may be set as any real number. A divided clock signal DCLK corresponding to an output of the frequency divider 3034c may be provided to the pattern phase detector 3032. The divided clock signal DCLK may be provided to the pattern controller 3033. The pattern controller 3033 may generate reference signals RS corresponding to a plurality of phases based on the divided clock signal DCLK.

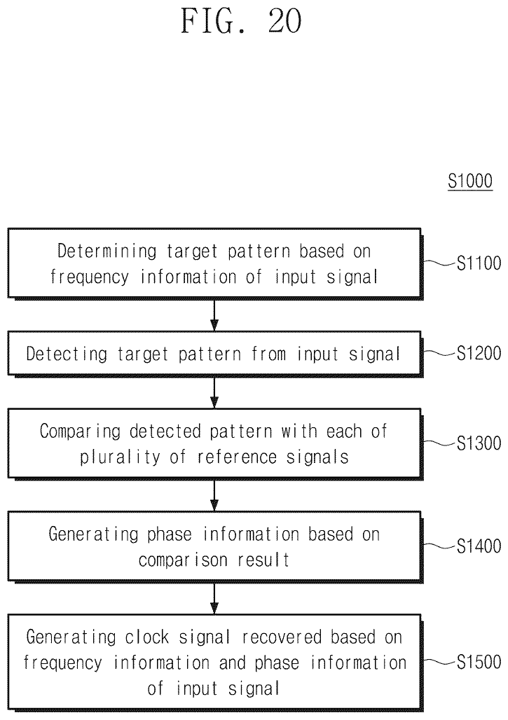

FIG. 20 is a flowchart illustrating a method of operating an input device according to an embodiment of the present disclosure.

Referring to FIG. 20, a method S1000 for operating the input device 3000 may include the steps of determining the target pattern TPT based on the frequency information FI of the input signal IS received from the sensor layer 200 (S1100); detecting the target pattern TPT from the input signal IS (S1200); comparing the detected pattern DPT with each of the plurality of reference signals RS (S1300); generating the phase information PHI based on the comparison result (S1400); and generating the recovered clock signal RCLK based on the frequency information FI and the phase information PHI of the input signal IS (S1500).

The step S1100 may be performed by the pattern controller 3033 in the time information recovery unit 3030. The step S1200 may be performed by the pattern detector 3031 in the time information recovery unit 3030. The steps S1300 and S1400 may be performed by the pattern phase detector 3032 in the time information recovery unit 3030. The step S1500 may be performed by the clock generator 3034 in the time information recovery unit 3030.

According to an embodiment of the present disclosure, the input device may not allocate separate time duration for correcting a clock or may not separately receive a correcting signal from the sensor layer. A modulated signal in which position information is encoded may be applied to the input device through the sensor layer. The input device may recover a clock signal synchronized with a base clock signal of a host device based on the input signal received from the sensor layer. By utilizing the recovered clock signal, the input device may increase the accuracy of the decoded position information. In addition, the frame rate may be improved.

According to an embodiment of the present disclosure, the input device may generate the clock signal synchronized with the clock signal of the host device, based on the input signal received from the sensor layer, without allocating the separate time duration for correcting the clock signal, or separately using the correcting signal.

The frame rate of the host device may be improved by omitting the separate time duration for correcting the clock signal and the separately-correcting signal. In addition, the clock signal of the input device may be fixed to the clock signal of the host device, and the accuracy of the position information recovered by the input device may be improved.

Although an exemplary embodiment of the present disclosure has been described for illustrative purposes, those skilled in the art will appreciate that various modifications, and substitutions are possible, without departing from the scope and spirit of the present disclosure as disclosed in the accompanying claims.

Accordingly, the technical scope of the present disclosure is not limited to the detailed description of this specification, but should be defined by the claims.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An input device comprising:
a sensing electrode configured to receive an input signal corresponding to a modulated signal which is output by a host device to a sensor layer;
an analog front-end configured to sense the input signal and convert the input signal to a digital code;
a digital back-end configured to recover position information on the sensor layer based on the digital code, and provide the position information to the host device; and
a time information recovery unit configured to output a recovered clock signal, which is fixed with a clock signal of the host device, based on the input signal.

2. The input device of claim 1, wherein the time information recovery unit includes:
a pattern controller configured to determine a target pattern for obtaining phase information of the input signal, and generate reference signals corresponding to a plurality of phases, respectively;
a pattern detector configured to compare the input signal with the target pattern, and output a detected pattern, based on the comparison result;
a pattern phase detector configured to generate the phase information based on the detected pattern and the reference signals; and
a clock generator configured to generate the recovered clock signal, based on frequency information of the input signal and the phase information of the input signal.

3. The input device of claim 2, wherein the pattern controller determines the target pattern based on the frequency information.

4. The input device of claim 3, wherein the pattern controller adjusts a frequency of the target pattern, based on a frequency change of the input signal.

5. The input device of claim 2, wherein the pattern controller generates the reference signals based on the recovered clock signal and the frequency information.

6. The input device of claim 2, wherein the pattern phase detector includes:
a plurality of phase comparators corresponding to the reference signals, respectively, to compare the reference signals, which correspond to the phase comparators, with the detected pattern, and generate phase comparison results;
a plurality of registers corresponding to the plurality of phase comparators, respectively, to store the phase comparison results; and
a selector configured to select a phase, which corresponds to the smallest phase difference, from among the phase comparison results stored in the plurality of registers, respectively.

7. The input device of claim 6, wherein the pattern phase detector further includes:
a post-processing unit to compare an edge of a reference signal having the selected phase with a transition timing of the detected pattern, and generate the phase information based on a comparison result between the edge with the transition timing.

8. The input device of claim 2, wherein the time information recovery unit further includes:
a delay compensator to compensate for a delay time of the detected pattern, based on a plurality of positions and phase/delay information corresponding to each of the plurality of positions.

9. The input device of claim 8, wherein each of the plurality of positions is a current position, a past position, or a future position expected.

10. The input device of claim 2, wherein the time information recovery unit further includes:
a frequency detector to sense a frequency of the input signal and generate the frequency information based on a sensing result.

11. An electronic device comprising:
a sensor layer including a plurality of electrodes;
a main driver configured to generate a first clock signal;
a sensor driver configured to output a modulated signal, which includes position information, to the sensor layer, based on the first clock signal; and
an input device configured to receive an input signal from the sensor layer, convert the input signal into a digital code, and recover the position information, based on the digital code,
wherein the input device generates a second clock signal fixed to the first clock signal, based on the input signal.

12. The electronic device of claim 11, wherein the input device detects a target pattern from the input signal, compares phase differences between the target pattern and reference signals corresponding to a plurality of phases, generate phase information based on a comparison result for the phase difference, and generate the second clock signal, based on frequency information of the input signal and the phase information of the input signal.

13. The electronic device of claim 12, wherein the input device determines the target pattern from among a plurality of patterns, based on the frequency information.

14. The electronic device of claim 13, wherein the input device adjusts a frequency of the target pattern, based on a frequency change of the modulated signal
15. The electronic device of claim 12, wherein the input device stores a plurality of positions and phase/delay information corresponding to each of the plurality of positions, and compensates for a delay time of the input signal, based on the position information.

16. A method of operating an input device, the method comprising:
determining a target pattern, based on frequency information of an input signal received, by a pattern controller;
detecting the target pattern from the input signal, by a pattern detector;
comparing the target pattern detected by the pattern detector with each of a plurality of reference signals corresponding to a plurality of phases, respectively, by a pattern phase detector;
generating phase information based on a comparison result, by the pattern phase detector; and
generating a clock signal recovered based on the frequency information and the phase information, by a pattern generator.

17. The method of claim 16, wherein the determining of the target pattern includes:
adjusting a frequency of the target pattern, based on a frequency change of the input signal.

18. The method of claim 16, wherein the generating of the phase information includes:
determining a phase having a smallest phase difference, based on the comparison result; and
comparing each edge of the phase determined to have the smallest phase difference with a transition timing of the target pattern detected by the pattern detector, and
wherein the phase information includes the comparison result between each edge of the phase and the transition timing of the target pattern.

19. The method of claim 16, further comprising:
compensating for a delay time of the detected pattern, based on a plurality of positions and phase/delay information corresponding to each of the plurality of positions, by a delay compensator.

20. The method of claim 16, further comprising:
sensing a frequency of the input signal and generating the frequency information based on a sensing result, by a frequency detector.
